(19) United States
(12) Patent Application Publication
(10) Pub. No.: US 2026/0184934 A1
(43) Pub. Date: Jul. 2, 2026

(54) COATING COMPOSITION AND METHOD OF PREPARING COATING COMPOSITION

(71) Applicants: DOW GLOBAL TECHNOLOGIES LLC, MIDLAND, MI (US); ROHM AND HAAS COMPANY, COLLEGEVILLE, PA (US)

(72) Inventors: Fengzhe SHI, Shanghai (CN); Yan WU, Shanghai (CN); Li ZHOU, Shanghai (CN); Xiaohong YANG, Shanghai (CN)

(21) Appl. No.: 19/130,789

(22) PCT Filed: Dec. 30, 2022
(86) PCT No.: PCT/CN2022/143787

§ 371 Date: May 16, 2025

(51) Int. Cl. C09D 5/02; C09D 7/61; C09D 7/63; C09D 133/06

(52) U.S. Cl. CPC C09D 5/022; C09D 5/028; C09D 7/61; C09D 7/63; C09D 133/064; C09D 133/066

(57) ABSTRACT

A coating composition comprising 20-38.5% of an aqueous dispersion of an acrylic (co)polymer; 0.5-2.9% of a water-soluble alkali metal silicate; an aqueous solution of a water-soluble non-alkali metal salt, comprising non-alkali metal ions; and 0-2% of a microfiller, where the listed percents are dry-weight based on weight of the composition. The aqueous solution of the non-alkali metal salt is present in an amount to provide a dry-weight ratio of the non-alkali metal ions to the acrylic (co)polymer of 0.13-3.3% and a dry-weight ratio of the non-alkali metal ions to the water-soluble alkali metal silicate of 1.4-42%. A method includes (i) admixing the aqueous dispersion of the acrylic (co)polymer with the aqueous solution of the water-soluble non-alkali metal salt (optionally, adding 0.06-0.52 wt % of ethylenediaminetetraacetic acid, a salt or mixtures thereof; (ii) further admixing the admixture obtained from step (i) with the water-soluble alkali metal silicate and any optional microfiller.

### FIELD

The present invention relates to a coating composition and a method of preparing the same.

### INTRODUCTION

Aqueous or waterborne coating compositions are becoming increasingly more important than solvent-based coating compositions for less environmental problems. Matt coating films are coating films having low gloss, normally at a level of below 50 on a 60° Gardner Gloss scale. In the wood coating industry, it is more desirable to provide a substrate with an even lower gloss finish. Adding microfillers such as conventional matting agents and pigments into coating compositions can reduce the gloss of coating films made therefrom. To achieve the desired low gloss, typically 2-3% by dry weight of matting agents are used, by solids weight of the coating compositions. Such high dosage of microfillers, however, usually results in coating films having undesirably low clarity with a haze value of equal or more than 33, and sometimes even compromises the hardness of coating films typically requiring F or harder for topcoats. Coating compositions also need to be stable, otherwise, grits formed in coating compositions tend to cause defects in the resulting coating films and compromise properties such as water resistance.

Therefore, it is desirable to provide a coating composition that provides coating films with balanced properties of low gloss and high clarity without compromising hardness.

### SUMMARY

The present invention solves the aforementioned problems by discovering a novel coating composition. The coating composition of the present invention can provide coating films with low gloss, high clarity and desirable hardness. Such coating composition is a novel combination of (a) an aqueous dispersion of an acrylic (co)polymer; (b) a water-soluble alkali metal silicate, and (c) an aqueous solution of a water-soluble non-alkali metal salt, comprising non-alkali metal ions at specified contents and ratios. The coating composition of the present invention provides a matt coating film without requiring the use of conventional microfillers (e.g., matting agents). The coating film shows a gloss level of less than 50 on a 60° Gardner Gloss scale, a haze value of less than 33, and a hardness of F or harder. The coating composition is also stable at room temperature (20-25 degrees Celsius (° C.)) as indicated by fineness less than 40 micrometers (μm). Desirably, the coating composition provides coating films with good water resistance with ratings of greater than 3. These properties can be determined according to the test methods described in the Examples section below.

In a first aspect, the present invention is a coating composition comprising, based on the weight of the coating composition,
(a) from 20% to 38.5% by dry weight of an aqueous dispersion of an acrylic (co)polymer;
(b) from 0.5% to 2.9% by dry weight of a water-soluble alkali metal silicate;
(c) an aqueous solution of a water-soluble non-alkali metal salt, comprising non-alkali metal ions; and
(d) from zero to 2% by dry weight of a microfiller;
wherein the aqueous solution of the non-alkali metal salt is present in an amount to provide a dry weight ratio of the non-alkali metal ions to the acrylic (co)polymer in a range of 0.13% to 3.3% and a dry weight ratio of the non-alkali metal ions to the water-soluble alkali metal silicate in a range of 1.4% to 42%.

In a second aspect, the present invention is a method of preparing the coating composition of the first aspect. The method comprises:
(i) admixing the aqueous dispersion of the acrylic (co)polymer with the aqueous solution of the water-soluble non-alkali metal salt, thereby forming an admixture;
(ii) further admixing the admixture obtained from step (i) with the water-soluble alkali metal silicate and the microfiller if present, and optionally,
adding from 0.06% to 0.52% by weight of ethylenediaminetetraacetic acid, a salt thereof, or mixtures thereof, based on the total weight of the coating composition, into the admixture obtained from step (i) and prior to step (ii).

### DETAILED DESCRIPTION

Test methods refer to the most recent test method as of the priority date of this document when a date is not indicated with the test method number. References to test methods contain both a reference to the testing society and the test method number. The following test method abbreviations and identifiers apply herein: ASTM refers to ASTM International methods, GB/T refers to national standard of the P. R. China, and EN refers to European standard.

Products identified by their tradename refer to the compositions available under those tradenames on the priority date of this document. “And/or” means “and, or as an alternative”. All ranges include endpoints unless otherwise indicated.

“Structural units”, also known as “polymerized units”, of the named monomer, refers to the remnant of the monomer after polymerization, that is, polymerized monomer or the monomer in polymerized form. For example, a structural unit of methyl methacrylate is as illustrated:

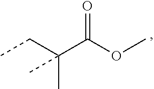

where the dotted lines represent the points of attachment of the structural unit to the polymer backbone.

“Nonionic monomer” herein refers to a monomer that does not bear an ionic charge between pH=1-14.

“Glass transition temperature” or “Tg” as used herein can be calculated by using a Fox equation (T. G. Fox, Bull. Am. Physics Soc., Volume 1, Issue No. 3, page 123 (1956)) below. For example, for calculating the Tg of a copolymer of monomers M1 and M2,

$$\frac{1}{{T}_{g} ( calc . )} = \frac{w ( {M}_{1} )}{{T}_{g} ( {M}_{1} )} + \frac{w ( {M}_{2} )}{{T}_{g} ( {M}_{2} )}$$

where T_{g}(calc.) is the glass transition temperature calculated for the copolymer, w(M₁) is the weight fraction of monomer M₁ in the copolymer, w(M₂) is the weight fraction of monomer M₂ in the copolymer, T_{g}(M₁) is the glass transition temperature of the homopolymer of monomer M₁, and T_{g}(M₂) is the glass transition temperature of the homopolymer of monomer M₂, all temperatures being in K. The glass transition temperatures of the homopolymers may be found, for example, in “Polymer Handbook”, edited by J. Brandrup and E. H. Immergut, Interscience Publishers.

The coating composition of the present invention comprises an aqueous dispersion of an acrylic (co)polymer, which is useful as a binder. “Aqueous” dispersion herein means that particles dispersed in an aqueous medium. By “aqueous medium” herein is meant water and from 0 to 30%, by weight based on the weight of the medium, of water-miscible compound(s) such as, for example, alcohols, glycols, glycol ethers, glycol esters, or mixtures thereof. A mixture of two or more acrylic (co)polymers can be used. “Acrylic (co)polymer” herein refers to a homopolymer of an acrylic monomer or a copolymer comprising structural units of an acrylic monomer with one or more additional monomers. “Acrylic” in the present invention includes (meth)acrylic acid, alkyl (meth)acrylate, (meth)acrylamide, (meth)acrylonitrile and their modified forms such as hydroxyalkyl (meth)acrylate. Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate. Specific examples of acrylic (co)polymer include acrylic homopolymers, styrene acrylic copolymers, or mixtures thereof.

The acrylic (co)polymer useful in the present invention may comprise structural units of one or more ethylenically unsaturated acid monomers, salts thereof, or mixtures thereof. The acid monomers and/or their salts may include a, O-ethylenically unsaturated carboxylic acids including an acid-bearing monomer such as methacrylic acid (MAA), acrylic acid (AA), itaconic acid, maleic acid, or fumaric acid; or a monomer bearing an acid-forming group which yields or is subsequently convertible to, such an acid group (such as anhydride, (meth)acrylic anhydride, or maleic anhydride); phosphorous-containing monomers such as vinyl phosphonic acid, allyl phosphonic acid, phosphoalkyl (meth)acrylates such as phosphoethyl (meth)acrylate, phosphopropyl (meth)acrylate, phosphobutyl (meth)acrylate, SIPOMER PAM-100, SIPOMER PAM-200, and SIPOMER PAM-300 all available from Solvay, phosphoalkoxy (meth)acrylates such as phospho ethylene glycol (meth)acrylate, phospho di-ethylene glycol (meth)acrylate, phospho tri-ethylene glycol (meth)acrylate, phospho propylene glycol (meth)acrylate, phospho di-propylene glycol (meth)acrylate, phospho tri-propylene glycol (meth)acrylate; sulfonic acid monomers and salts thereof including, for example, 2-acrylamido-2-methyl-1-propanesulfonic acid; sodium salt of 2-acrylamido-2-methyl-1-propanesulfonic acid; and ammonium salt of 2-acrylamido-2-methyl-1-propane sulfonic acid; sodium p-styrene sulfonate (SSS); sodium vinyl sulfonate (SVS); sodium salt of allyl ether sulfonate; salts thereof; and mixtures thereof. Desirably, the acid monomer is an α, β-ethylenically unsaturated carboxylic acid. More desirably, the acid monomer includes acrylic acid, methyl acrylic acid, SSS, or mixtures thereof, and more desirably, the acid monomer is MAA. The acrylic (co)polymer may comprise structural units of the acid monomer at a concentration of 0.1% to 20%, and can be 0.1% to 15%, 0.3% to 12%, 0.5% to 10%, or 0.7% to 8%, by weight based on the weight of the acrylic (co)polymer.

The acrylic (co)polymer useful in the present invention may comprise or be free of structural units of one or more ethylenically unsaturated monomers carrying at least one functional group selected from an amide, ureido, carbonyl, or silane group, or combinations thereof (hereinafter “functional monomer”). Suitable functional monomers may include, for example, carbonyl-containing functional monomers such as acetoacetoxyethyl methacrylate (AAEM) and diacetone acrylamide (DAAM), acrylamide, methacrylamide, vinyltrialkoxysilanes such as vinyltrimethoxysilane, (meth)acryloxyalkyltrialkoxysilanes such as (meth)acryloxyethyltrimethoxysilane and (meth)acryloxypropyltrimethoxysilane, or mixtures thereof. Desirably, the functional monomer comprises acrylamide, DAAM, ureido-containing monomers, or mixtures thereof. The acrylic (co)polymer may comprise structural units of the functional monomer and salt thereof at a concentration of 0.1% to 20%, and can be 0.1% to 15%, 0.3% to 12%, 0.5% to 10%, or 0.7% to 8%, by weight based on the weight of the acrylic (co)polymer.

The acrylic (co)polymer useful in the present invention may comprise or be free of structural units of one or more ethylenically unsaturated nonionic monomers other than the functional monomer described above. The term “nonionic monomers” refers to monomers that do not bear an ionic charge between pH=1-14. Suitable ethylenically unsaturated nonionic monomers may include an alkyl ester of (meth)acrylic acid; a hydroxy-functional alkyl (meth)acrylate; a cycloalkyl (meth)arylate such as cyclohexyl (meth)acrylate, vinyl aromatic monomers such as styrene and substituted styrene (including for example .alpha.-methyl styrene, p-methyl styrene, t-butyl styrene, vinyltoluene); glycidyl (meth)acrylate; α-olefins such as ethylene, propylene, and 1-decene; vinyl, vinyl butyrate, vinyl versatate and other vinyl esters; nitrile-containing monomers such as acrylonitrile (AN); or mixtures thereof. “Alkyl” means a linear or branched alkyl group. The alkyl ester of (meth)acrylic acid may be selected from C₁-C₂-alkyl(meth)acrylates, C₄-C₂₀-alkyl (meth)acrylates, or mixtures thereof. The C₄-C₂₀-alkyl (meth)acrylates refer to alkyl esters of (meth)acrylic acid containing an alkyl with from 4 to 20 carbon atoms, or from 4 to 18 carbon atoms. Examples of C₄-C₂₀-alkyl (meth)acrylates include butyl (meth)acrylate, iso-butyl (meth)acrylate, 2-ethylhexyl (meth)acrylate, lauryl (meth)acrylate, stearyl (meth)acrylate, benzyl(meth)acrylate, oleyl(meth)acrylate, palmityl (meth)acrylate, nonyl(meth)acrylate, decyl (meth)acrylate, dodecyl (meth)acrylate, pentadecyl (meth) acrylate, hexadecyl (meth)acrylate, octadecyl (meth)acrylate, or mixtures thereof. Desirably, the C₄-C₂₀-alkyl (meth)acrylate is selected from 2-ethylhexyl acrylate (EHA), butyl (meth)acrylate, or mixtures thereof. Suitable C₁-C₂-alkyl(meth)acrylates may include methyl (meth)acrylate, ethyl (meth)acrylate, or mixtures thereof. Suitable hydroxy-functional alkyl (meth)acrylates may include hydroxyethyl (meth)acrylates, hydroxypropyl (meth)acrylates, hydroxybutyl (meth)acrylates, 6-hydroxyhexyl (meth)acrylate, 3-hydroxy-2-ethylhexyl (meth)acrylate, or mixtures thereof. Desirably, the hydroxy-functional alkyl (meth)acrylate is selected from the group consisting of 2-hydroxyethyl acrylate, 2-hydroxyethyl methacrylate (HEMA), 2-hydroxypropyl acrylate, 2-hydroxypropyl methacrylate, 3-hydroxypropyl acrylate, 3-hydroxypropyl methacrylate, and mixtures thereof. Desirably, the ethylenically unsaturated nonionic monomers are selected from styrene, HEMA, acrylonitrile, methyl (meth)acrylate, cyclohexyl (meth)acrylate, ethyl (meth)acrylate, butyl methacrylate, butyl acrylate (BA), EHA, or mixtures thereof. Desirably, the acrylic (co)polymer comprises structural units of the hydroxy-functional alkyl (meth)acrylate, typically present in an amount of from 0.1% to 45%, and can be 0.1% or more, 0.5% or more, 1% or more, 2% or more, 5% or more, 7% or more, 10% or more, even 12% or more while at the same time is 45% or less, and can be 40% or less, 35% or less, 33% or less, or even 30% or less, and more desirably, 1% to 33%, by weight based on the weight of the acrylic (co)polymer. Alternatively, the acrylic (co)polymer may comprise structural units of acrylonitrile at a concentration of from 0.5% to 40%, and can be from 1% to 35%, 2% to 33%, 5% to 30%, 10% to 28%, 15% to 27%, or 19% to 25%, by weight based on the weight of the acrylic (co)polymer. Alternatively, the acrylic (co)polymer may comprise structural units of styrene at a concentration of zero to 60%, and can be 5% to 55%, 10% to 50%, or 20% to 45%, by weight based on the weight of the acrylic (co)polymer. The acrylic (co)polymer may comprise 20% to 99.8% of structural units of the alkyl ester of (meth)acrylic acid, and can be 25% to 99.5%, 30% to 98%, 50% to 95%, 55% to 90%, or 60% to 90%, by weight based on the weight of the acrylic (co)polymer. The acrylic (co)polymer may comprise or be free of structural units of a multifunctional nonionic monomer such as butadiene, divinylbenzene, and allyl (meth)acrylate, typically at a concentration of zero to 5%, and can be zero to 2%, 0.1% to 1%, or 0.1% to 0.5%, by weight based on the weight of the acrylic (co)polymer. The acrylic (co)polymer may comprise structural units of the ethylenically unsaturated nonionic monomer at a total concentration of 80% to 99.9%, and can be 85% to 99.5%, 88% to 98%, 90% to 97.5%, or 90% to 95%, by weight based on the weight of the acrylic (co)polymer.

The acrylic (co)polymer can be a multistage acrylic (co)polymer comprising a polymer A and a polymer B where a Tg difference between the polymer A and the polymer B is 40° C. or more, and can be 45° C. or more, 50° C. or more, 55° C. or more, 60° C. or more, 65° C. or more, 70° C. or more, or even 75° C. or more. The weight ratio of the polymer A to the polymer B can be in a range of 20:80 to 80:20, and can be 22:78 to 78:22, 25:75 to 75:25, 30:70 to 70:30, 35:65 to 65:35, 38:62 to 60:40, or 40:46 to 55:45, and desirably, 22:78 to 78:22 or 38:62 to 55:45.

Desirably, the acrylic (co)polymer is a multistage acrylic (co)polymer having a Tg in a range of from 0 to 80° C. and comprising a polymer A and a polymer B at a weight ratio of the polymer A to polymer B in a range of from 78:22 to 22:78,
wherein a Tg difference between the polymer A and the polymer B is 40° C. or more, and
wherein the multistage acrylic (co)polymer comprises, by weight based on the weight of the multistage acrylic (co)polymer,
from 10% to 40% of structural units of the cycloalkyl (meth)acrylate such as cyclohexyl methacrylate;
from 40% to 85% of structural units of the C₄-C₂₀-alkyl (meth)acrylate, the vinyl aromatic monomer, or mixtures thereof, such as BA, EHA, styrene, or mixtures thereof; and
from 0.5% to 10% of structural units of the acid monomer, the salt thereof, or mixtures thereof.

Alternatively, the acrylic (co)polymer can be a multistage acrylic (co)polymer comprising a polymer A and a polymer B, wherein the polymer A has a number average molecular weight (Mn) of from 3,000 to 50,000 and comprises, by weight based on the weight of the polymer A,
(a1) from 2.1% to 10% of structural units of the carbonyl-containing functional monomer such as DAAM;
(a2) from 5% to 15% of structural units of the acid monomer, the salt thereof, or mixtures thereof; and
(a3) from 75% to 92% of structural units of methyl (meth)acrylate, ethyl (meth)acrylate, or mixtures thereof; and
wherein the polymer B comprises as polymerized units, by weight based on the weight of the polymer B,
(b1) from 0.8% to 10% of structural units of the carbonyl-containing functional monomer such as DAAM, and
(b2) from 90% to 99.2% of structural units of the ethylenically unsaturated nonionic monomer;
wherein the polymer B has a glass transition temperature at least 40° C. lower than that of the polymer A, and the weight ratio of the polymer A to the polymer B is from 38:62 to 55:45.

The polymer A in the multistage polymer may have a Mn of 3,000 or more, and can be 4,500 or more, even 5,000 or more while at the same time is 50,000 or less, and can be 30,000 or less, 20,000 or less, or even 10,000 or less. Mn may be determined by Gel Permeation Chromatography (GPC) analysis using polystyrene as the standard or calculated as follows,

$$Mn = [ W ( monomer ) + W ( C T A ) ] / Mole ( C T A ) ,$$

wherein W(monomer) is the total weight of monomers used in preparing the polymer A, W(CTA) is the weight of a chain transfer agent used in preparing the polymer A, and Mole(CTA) is the moles of the chain transfer agent used in preparing the polymer A.

The coating composition of the present invention may comprise, based on the weight of the coating composition, from 20% to 38.5% by dry weight of the aqueous dispersion of the acrylic (co)polymer, and can be 20.5% or more, 21% or more, 22% or more, 22.5% or more, even 23% by dry weight or more while at the same time is 38.5% or less, and can be 35% or less, 32% or less, 30% or less, less than 30%, 28% or less, or even 27% by dry weight or less, and desirably, less than 30%, from 21% to 30%, or from 23% to 27% by dry weight.

The acrylic (co)polymer useful in the present invention can be prepared by free-radical polymerization of the monomers described above, desirably, emulsion polymerization. Total weight concentration of structural units of the acrylic (co)polymer is equal to 100% relative to the weight of the acrylic (co)polymer. One-stage or multistage free-radical polymerization can be used. When the acrylic (co)polymer is a multistage acrylic (co)polymer prepared by multistage free-radical polymerization, the multistage free-radical polymerization involves at least two stages formed sequentially (e.g., the first stage and the second stage), and usually results in the formation of the multistage acrylic (co)polymer comprising at least two polymer compositions, i.e., the polymer A and the polymer B. The total weight concentration of structural units in the polymer A and in the polymer B is each equal to 100% relative to the polymer A weight and polymer B weight, respectively.

The emulsion polymerization can be conducted at conventional conditions including the use of a free radical initiator, a surfactant, a chain transfer agent, or combinations thereof. The surfactant may be added prior to or during the polymerization of the monomers, or combinations thereof. A portion of the surfactant can also be added after the polymerization. These surfactants may include anionic and/or nonionic emulsifiers, typically at a concentration of from 0.1% to 6% or from 0.3% to 1.5%, by weight based on the weight of total monomers used for preparing the acrylic (co)polymer. Examples of suitable chain transfer agents include 3-mercaptopropionic acid, dodecyl mercaptan, methyl 3-mercaptopropionate, butyl 3-mercaptopropionate, benzenethiol, azelaic alkyl mercaptan, or mixtures thereof. When preparing the multistage acrylic (co)polymer, the chain transfer agent can be added in the first stage of the multistage polymerization in an effective amount to control the molecular weight of the first stage polymer (e.g., the polymer A), for example, at a concentration of greater than 1.2%, and can be 1.3% or more, 1.4% or more, 1.5% or more, 1.6% or more, 1.7% or more, 1.8% or more, or even 1.9% or more, while at the same time is generally 10% or less, 9% or less, 8% or less, 7% or less, 6% or less, 5% or less, or even 4% or less, by weight based on the total weight of monomers used in the first stage of the multistage polymerization. After completing the polymerization process, the obtained acrylic (co)polymer may be controlled to a pH value of at least 6, for example, from 6 to 11, or from 7 to 10, by neutralization using one or more bases which may lead to partial or complete neutralization of the ionic or latently ionic groups of the acrylic (co)polymer. Commercially available aqueous acrylic (co)polymer dispersions may include, for example, ROSHIELD™ PR-600, ROSHIELD™ P200, RHOPLEX™ WL-91, and MAINCOTE™ HG-54C emulsions all available from The Dow Chemical Company, or mixtures thereof (ROSHIELD, RHOPLEX, and MAINCOTE are trademarks of The Dow Chemical Company).

The acrylic (co)polymer particles in the aqueous dispersion may have an average particle size of 30 nanometers (nm) or more, and can be 80 nm or more, 90 nm or more, 100 nm or more, greater than 100 nm, 105 nm or more, even 110 nm or more while at the same time is generally 500 nm or less, and can be 300 nm or less, or even 200 nm or less, or even 150 nm or less. The particle size herein refers to the number average particle size and may be measured by a Brookhaven BI-90 Plus Particle Size Analyzer.

The aqueous dispersion of the acrylic (co)polymer useful in the present invention further comprises water. Water may be present in an amount of 30% or more, and can be 40% or more, even 50% or more while at the same time is generally 90% or less, and can be 85% or less, or even 80% or less, by weight based on the total weight of the aqueous dispersion. The coating composition may comprise from 47% to 89% of the aqueous dispersion of the acrylic (co)polymer, and can be from 50% to 80%, from 50.5% to 77%, from 51% to 75%, from 52% to 70%, or from 53% to 66%, and desirably, from 54% to 62%, by wet weight based on the weight of the coating composition.

The coating composition of the present invention may comprise or be free of a polyfunctional carboxylic hydrazide containing at least two hydrazide groups per molecule, particularly when the acrylic (co)polymer comprising structual units of the carbonyl-containing functional monomer. The polyfunctional carboxylic hydrazides may act as a crosslinker and may be selected from the group consisting of adipic dihydrazide, oxalic dihydrazide, isophthalic dihydrazide, and polyacrylic polyhydrazide. When present, the concentration of the polyfunctional carboxylic hydrazide may be from 0.5% to 10% by weight or from 1% to 5% by weight, based on the weight of the acrylic (co)polymer.

The coating composition of the present invention may also comprise or be free of an aqueous polyurethane dispersion which is useful as a binder, typically present in an amount of zero to 15%, and can be zero or more, 1% or more, 2% or more, even 5% or more while at the same time is 15% or less, and can be 12.5% or less, or even 10.5% or less, by dry weight based on the weight of the coating composition.

The coating composition of the present invention also comprises a water-soluble alkali metal silicate. The alkali metal silicate can be sodium silicates, potassium silicates, lithium silicates, or combinations thereof. Suitable alkali metal silicates can be any silicate of the general formula of M₂O·xSiO₂, where M represents an alkali metal, including lithium, sodium, potassium, and combinations thereof; and x represents the molar ratio of silica (SiO₂) to metal oxide (M₂O). Sodium silicates (Na₂O·xSiO₂) usually have the molar ratio of Na₂O to SiO₂ in a range of 1:4 to 2:1. Suitable sodium silicates may include, for example, sodium orthosilicate (Na₄SiO₄), sodium metasilicate (Na₂SiO₃), sodium disilicate (Na₂Si₂O₅), sodium tetrasilicate (Na₂Si₄O₉), sodium pyrosilicate (Na₆Si₂O₇), other sodium polysilicates, or mixtures thereof. Potassium silicates (K₂O·xSiO₂) usually have the molar ratio of K₂O to SiO₂ between 0.2 to 1. Potassium silicates including all variable compositions from K₂Si₂O₅ to K₂Si₃O₇ can be used. Lithium silicates (Li₂O·xSiO₂) typically have the molar ratio of Li₂O to SiO₂ between 0.3 and 8. A mixture of two or more water-soluble different alkali metal silicates can be used. Mixed water-soluble alkali metal silicates, such as potassium sodium silicate, lithium potassium silicate, or mixtures thereof can be used. Desirably, the water-soluble alkali metal silicate is a lithium potassium silicate.

The coating composition of the present invention may comprise, based on the weight of the coating composition, from 0.5% to 2.9% by dry weight of the water-soluble alkali metal silicate, and can be 0.5% or more, 0.55% or more, 0.6% or more, 0.65% or more, 0.7% or more, higher than 0.75%, 0.8% or more, 0.9% or more, even 1% or more while at the same time is 2.9% or less, and can be 2.85% or less, 2.8% or less, 2.7% or less, 2.6% or less, 2.5% or less, 2.4% or less, 2.3% or less, 2.2% or less, 2.1% or less, 2% or less, 1.8% or less, 1.5% or less, 1.2% or less, or even 1% or less. Desirably, the coating composition comprises from 0.9% to 2.7% or from 1% to 2.5% by dry weight of the water-soluble alkali metal silicate, based on the weight of the coating composition.

The water-soluble alkali metal silicate can be supplied as an aqueous solution, typically comprising 5% to 80%, 10% to 70%, or 15% to 60% by dry weight of the water-soluble alkali metal silicate, based on the weight of such aqueous solution. The aqueous solution of the water-soluble alkali metal silicate may be present in an amount of from 2% to 27.5%, and can be 2% or more, 2.25% or more, 2.5% or more, 2.75% or more, 3% or more, 3.5% or more, even 4% or more while at the same time is 27.5% or less, and can be 25% or less, 22.5% or less, 20% or less, 18% or less, 15% or less, or even 12% or less, by wet weight based on the weight of the coating composition.

The coating composition of the present invention also comprises an aqueous solution of a water-soluble non-alkali metal salt, comprising non-alkali metal ions. The water-soluble non-alkali metal salt may include, for example, a zinc ammonia complex salt, an aluminum salt, a zirconium salt, or mixtures thereof. Such non-alkali metal salt in water (thus forming an aqueous solution) can provide multivalent cations. Such aqueous solution may include zinc ions (Zn²⁺), aluminum ions (Al³⁺), zirconium ions (Zr⁴⁺), or mixtures thereof.

The non-alkali metal salt useful in the present invention may comprise or consist of a zinc ammonia complex salt. The zinc ammonia complex salt is water-soluble. The zinc ammonia complex salt may be selected from zinc ammonium bicarbonate, zinc ammonium nitrate, zinc ammonium acetate, or mixtures thereof, and desirably, zinc ammonia carbonate. The zinc ammonia complex salt can be prepared by mixing one or more zinc salts and/or zinc oxides, ammonia, and optionally a water-soluble carbonic acid salt such as ammonium bicarbonate. Ammonia is added in a sufficient amount to provide the aqueous solution of the zinc ammonia complex salt with a pH above 9, desirably above 9.5. Ammonia is in the presence of excess equivalents to form a zinc ammonia complex. Examples of zinc salts include zinc carbonate, zinc acetate, zinc chloride, zinc nitrate, or mixtures thereof. The aqueous solution of the zinc ammonia complex salt comprises zinc ions and ammonium ions.

The non-alkali metal salt useful in the present invention may comprise or consist of one or more water-soluble aluminum salts. The aqueous solution of the aluminum chloride salt can be prepared by dissolving aluminum trichloride powder into water. The aluminum salts may include aluminum chloride (AlCl₃), aluminum nitrate, or mixtures thereof.

The aqueous solution of the non-alkali metal salt may be present in an amount sufficient to provide a dry weight ratio of the non-alkali metal ions to the acrylic (co)polymer of 0.13% to 3.3%, and can be 0.13% or more, 0.14% or more, 0.15% or more, 0.2% or more, 0.3% or more, 0.4% or more, 0.5% or more, 0.65% or more, 0.7% or more, 0.8% or more, or even 1.0% or more, while at the same time, 3.3% or less, and can be 3.2% or less, 3.1% or less, 3% or less, 2.9% or less, 2.5% or less, 2.4% or less, 2% or less, 1.5% or less, 1.3% or less, 1.2% or less, or even 1.1% or less. Desirably, the dry weight ratio of the non-alkali metal ions to the acrylic (co)polymer is in a range of 0.5% to 2.5%, 0.7% to 2%, or 0.8% to 1.2%. At the same time, the amount of the aqueous solution of the non-alkali metal salt may provide a dry weight ratio of the non-alkali metal ions to the water-soluble alkali metal silicate in a range of from 1.4% to 42%, and can be 1.4% or more, 1.5% or more, 2% or more, 5% or more, 7.5% or more, 10% or more, 13% or more, 14% or more, even 20% or more while at the same time is 42% or less, and can be 41% or less, 40.5% or less, 38% or less, 35% or less, 33% or less, 30% or less, 28% or less, 27% or less, 25% or less, 22% or less, or even 21% or less. Desirably, the dry weight ratio of the non-alkali metal ions to the water-soluble alkali metal silicate is in a range of 5% to 35%, 7.5% to 33%, or 10% to 30%.

The coating composition of the present invention may comprise or be free of ethylenediaminetetraacetic acid (EDTA), a salt thereof such as ethylenediaminetetraacetic acid sodium salt, or mixtures thereof. Addition of EDTA and/or EDTA salt is useful to further increase stability of the coating composition, particularly when using an aqueous acrylic (co)polymer dispersion with binding power of lower than 0.975 in the coating composition. “Binding power” refers to the ability of an aqueous dispersion of the acrylic (co)polymer to capture non-alkali metal ions, as measured by centrifugation of a mixture comprising the aqueous acrylic (co)polymer dispersion and non-alkali metal ions. The binding power is calculated by weight percentage of non-alkali metal ions in sedimentation after centrifugation of the mixture relative to total non-alkali ions in the mixture prior to centrifugation (further details can be found in the Binding Power Test in the Examples section below).

The coating composition may comprise ethylenediaminetetraacetic acid and/or the salt thereof at a concentration of from zero to 0.52%, and can be greater than zero, 0.06% or more, 0.07% or more, even 0.09% or more while at the same time is generally 0.52% or less, and can be 0.4% or less, or even 0.35% or less, and desirably, from 0.07% to 0.4% or from 0.09% to 0.35%, by weight based on the weight of the coating composition.

The coating composition of the present invention may comprise or be free of microfillers. “Microfillers” refers to any organic or inorganic particles have an d50 particle size of from 0.5 to 40 μm, according to the ASTM E2651-10 method, and typically have a d50 particle size of from 0.5 to 30 μm, from 1 to 20 μm, or from 1 to 10 μm. Examples of microfillers include matting agents, pigments, extenders, fillers, or mixtures thereof. “Matting agents” herein refers to any inorganic or organic particles that provide matt effects. The matting agents may be a silica, polyurea, polyacrylate polyethylene, or polytetrafluoroethene matting agents, or mixtures thereof. The matting agent may be in the form of powders or an emulsion. The coating composition may comprise the microfiller at a concentration of zero to 2%, and can be 2% or less, 1.5% or less, 1% or less, less than 1%, 0.5% or less, 0.1% or less, less than 0.1%, or even zero, by dry weight based on the weight of the coating composition.

The coating composition of the present invention may comprise or be free of one or more defoamers. “Defoamers” herein refers to chemical additives that reduce and hinder the formation of foam. Defoamers may be silicone-based defoamers, mineral oil-based defoamers, ethylene oxide/propylene oxide-based defoamers, alkyl polyacrylates, or mixtures thereof. The defoamer may be present at a concentration of zero to 2%, from 0.1% to 1%, or from 0.2% to 0.5%, by weight based on the weight of the coating composition.

The coating composition of the present invention may comprise or be free of one or more thickeners (also known as “rheology modifiers”). Thickeners may include polyvinyl alcohol (PVA), clay materials, acid derivatives, acid copolymers, urethane associate thickeners (UAT), polyether urea polyurethanes (PEUPU), polyether polyurethanes (PEPU), or mixtures thereof. Examples of suitable thickeners include alkali swellable emulsions (ASE) such as sodium or ammonium neutralized acrylic acid polymers; hydrophobically modified alkali swellable emulsions (HASE) such as hydrophobically modified acrylic acid copolymers; associative thickeners such as hydrophobically modified ethoxylated urethanes (HEUR); and cellulosic thickeners such as methyl cellulose ethers, hydroxymethyl cellulose (HMC), hydroxyethyl cellulose (HEC), hydrophobically-modified hydroxy ethyl cellulose (HMHEC), sodium carboxymethyl cellulose (SCMC), sodium carboxymethyl 2-hydroxyethyl cellulose, 2-hydroxypropyl methyl cellulose, 2-hydroxyethyl methyl cellulose, 2-hydroxydebutyl methyl cellulose, 2-hydroxyethyl ethyl cellulose, and 2-hydoxypropyl cellulose, and preferably HEUR. The thickener may be present at a concentration of from zero to 2%, from 0.02% to 1%, or from 0.04% to 0.5%, by weight based on the weight of the coating composition.

The coating composition of the present invention may comprise or be free of one or more wetting agents. “Wetting agents” herein refer to chemical additives that reduce the surface tension of a coating composition, causing the coating composition to more easily spread across or penetrate the surface of a substrate. Wetting agents can be polycarboxylates, anionic, zwitterionic, or non-ionic. The wetting agent may be present at a concentration of from zero to 2%, from 0.05% to 1%, or from 0.1% to 0.5%, by weight based on the weight of the coating composition.

The coating composition of the present invention may comprise or be free of one or more coalescents. “Coalescents” herein refer to slow-evaporating solvents that fuse polymer particles into a continuous film under ambient condition. Examples of suitable coalescents include 2-n-butoxyethanol, dipropylene glycol n-butyl ether, propylene glycol n-butyl ether, dipropylene glycol methyl ether, propylene glycol methyl ether, propylene glycol n-propyl ether, diethylene glycol monobutyl ether, ethylene glycol monobutyl ether, ethylene glycol monohexyl ether, triethylene glycol monobutyl ether, dipropylene glycol n-propyl ether, n-butyl ether, or mixtures thereof. Preferred coalescents include dipropylene glycol n-butyl ether, ethylene glycol monobutyl ether, diethylene glycol monobutyl ether, n-butyl ether, or mixtures thereof. The coalescents may be present at a concentration of from zero to 20%, from 0.5% to 15%, or from 1% to 10%, by weight based on the weight of the coating composition.

The coating composition of the present invention is typically an aqueous coating composition comprising water generally present at a concentration of from 20% to 90%, from 40% to 85%, or from 50% to 80%, by weight based on the weight of the coating composition.

In addition to the components described above, the coating composition of the present invention may further comprise any one or combination of the following additives: buffers, neutralizers, dispersants, humectants, biocides, anti-skinning agents, colorants, flowing agents, anti-oxidants, plasticizers, freeze/thaw additives, leveling agents, thixotropic agents, adhesion promoters, anti-scratch additives, and grind vehicles.

These additives may be present in a total concentration of from zero to 5%, from 0.001% to 3%, or from 0.1% to 2%, by weight based on the weight of the coating composition.

The pH value of the coating composition of the present invention is typically higher than 7, and can be 7.5 to 11 or 8.5 to 10.

The present invention also relates to a method of preparing the coating composition of the present invention. The method may comprise the steps of: (i) admixing the aqueous dispersion of the acrylic (co)polymer with the aqueous solution of the water-soluble non-alkali metal salt, thereby forming an admixture, and (ii) further admixing the admixture obtained from step (i) with the water-soluble alkali metal silicate and the microfiller if present. Optional components such as ethylene diamine tetraacetic acid and/or the salt thereof described above may be added into the admixture obtained from step (i) prior to step (ii). Desirably, the method further comprises adjusting the pH value of the admixture obtained from step (i) to 9 or higher or even 9.5 higher, e.g., by ammonia solution, prior to admixing with the aqueous solution of the water-soluble alkali metal silicate. Any of other above-mentioned optional components such the microfiller may also be added to the composition together with the water-soluble alkali metal silicate or after step (ii).

The present invention also provides a process for preparing a coating. The process may comprise: forming the coating composition of the present invention, applying the coating composition to a substrate, and drying, or allowing to dry, the applied coating composition to form the coating. The coating composition can be used alone, or in combination with other coatings to form multi-layer coatings. The coating composition can be applied to a substrate by incumbent means including brushing, dipping, rolling and spraying. Desirably, the coating composition is applied by spraying. The standard spray techniques and equipment for spraying such as air-atomized spray, air spray, airless spray, high volume low pressure spray, and electrostatic spray such as electrostatic bell application, and either manual or automatic methods can be used. After the coating composition of the present invention has been applied to a substrate, the coating composition can dry, or allow to dry, to form a film (this is, coating) at room temperature, or at an elevated temperature, for example, from 35° C. to 60° C. The coating composition can be applied to, and adhered to, various substrates, particularly wood. The coating composition is particularly suitable for furniture coatings, joinery coatings, and floor coatings. The coatings on the substrate typically have a dry film thickness of 30 to 80 μm.

The coating made from the coating composition of the present invention demonstrates a low gloss, high clarity, while achieving a pencil hardness with a rating of F or harder as measured according to GB/T 6739-2006. “Low gloss” means a gloss level of less than 50, and desirably below 30, on a 60° Gardner Gloss scale, as determined by using a BYK Micro-Tri-Gloss meter according to ASTM D523. “High clarity” means a haze value of less than 33, as measured by BYK Haze-gard dual haze meter. Desirably, the coatings further show good water resistance with a rating of 4 or higher, as measured according to EN 12720-2009. Further details for measuring these properties are provided in the Examples section below. The coating composition of the present invention is particularly suitable for preparing clear coatings.

### Examples

Some embodiments of the invention will now be described in the following Examples, wherein percentage (%) is weight percentage relative to composition weight, unless otherwise specified. The materials for use in the coating composition of the samples are described herein below. ROSHIELD, RHOPLEX, MAINCOTE, DOWANOL, and OPTI-MATT are trademarks of The Dow Chemical Company.

TABLE 1

| Material | Chemical description | Function | Source |
|---|---|---|---|
| ROSHIELD ™ 500 emulsion | Acrylic latex (solids content: 40%) | Binder | The Dow Chemical Company |
| ROSHIELD ™ PR-600 | Acrylic latex (solids content: 42%) | Binder | The Dow Chemical Company |
| emulsion | | | |
| ROSHIELD ™ P200 emulsion | Hydroxyl-functional acrylic latex | Binder | The Dow Chemical Company |
| | (solids content: 42%) | | |
| RHOPLEX ™ WL-91 | Acrylic latex (solids content: 41.5%) | Binder | The Dow Chemical Company |
| emulsion | | | |
| MAINCOTE ™ HG-54C | Acrylic latex (solids content: 41.5%) | Binder | The Dow Chemical Company |
| emulsion | | | |
| CB-956 | Lithium potassium silicate aqueous | Water-soluble | Connell |
| | solution (solids content: 25% by weight | silicate | |
| | relative to solution weight) | | |
| BYK-345 | Polyether-modified siloxane | Wetting agent | BYK |
| BYK-024 | Mixture of foam-destroying | Defoamer | BYK |
| | polysiloxanes and hydrophobic solids | | |
| | in polyglycol | | |
| Aqueous ammonia (25%) | | | Sinopharm Chemical Reagent Co., |
| | | | Ltd |
| Zinc/ammonia solution | Aqueous solution of Zinc/ammonia | Zn²⁺ ions | Prepared by adding ZnO powder |
| | complex salt, containing 6.57% by | | (28.7 grams (g)) and ammonium |
| | weight of Zn²⁺, based on the weight of | | hydrogen carbonate (40 g) into a |
| | the solution. | | container, and then adding water (216 |
| | | | g) to the resulting solid mixture under |
| | | | stirring, and further adding ammonia |
| | | | water (66 g) under stirring until a |
| | | | transparent solution was obtained. |
| AlCl₃ solution | AlCl₃ aqueous solution containing | Al³⁺ ions | Prepared by adding water (70 g) into |
| | 6.07% by weight of trivalent Al ions | | a container and further adding AlCl₃ |
| | (Al³⁺), based on the weight of the | | powder (30 g) into the container |
| | solution. | | under stirring until a transparent |
| | | | solution was obtained. |
| DOWANOL ™ EB | 2-Butoxy ethanol | Coalescent | The Dow Chemical Company |
| DOWANOL ™ DB | Diethylene glycol monobutyl ether | Coalescent | The Dow Chemical Company |
| DOWANOL ™ DPnB | Dipropylene glycol n-butyl ether | Coalescent | The Dow Chemical Company |
| OPTI-MATT ™ AB-2 duller | Acrylic matting beads (31.5% solids, | Matting agent | The Dow Chemical Company |
| | d50 < 30 μm) | | |
| ACEMATT ™ TS 100 | Untreated thermal silica (d50 = 9.5 μm) | Matting agent | Evonik |
| EDTA | Ethylene diamine tetraacetic acid | | Sinopharm Chemical Reagent Co., |
| | | | Ltd. |

The following standard analytical equipment and methods are used in the Examples and in determining the properties and characteristics stated herein: Preparation of Coated Panels

### 1) Coated Wood Panels

Wood substrate was applied with three-layer coatings by applying 80-90 grams per square meter (g/m²) of the wood panel of a test coating composition for each layer. After applying the first layer of the coating composition, panels were left at room temperature for 4 hours and then sanded with sanding paper. Then the second layer of the coating composition was applied, dried and sanded using the same procedure as for the first layer. After applying the third layer of the coating composition, the coated wood panel was dried at room temperature for 4 hours, and then placed in an oven at 50° C. for 48 hours before testing.

### 2) Coated Glass Panels

A test coating composition was applied onto a glass substrate by drawdown at a wet thickness of 150 μm. Only one layer of the coating composition was applied. The coating on glass was dried at room temperatures for 4 hours, and then placed in an oven at 50° C. for 48 hours before testing.

### 3) Coated Vinyl Chart

A test coating composition was applied onto vinyl chart by drawdown at a wet thickness of 150 μm. Only one layer of the coating composition was applied. The coating on vinyl chart was dried at room temperature for 4 hours and then placed in an oven at 50° C. for 48 hours before testing.

### Water Resistance Test

Determine water resistance and alcohol resistance according to EN 12720-2009.

For the water resistance test, filter discs were first saturated with deionized water, placed on the above-prepared coated wood panels, and covered with a cap to reduce evaporation. After 24 hours, the cap was removed. Tested areas were wiped with wet facial tissues and allowed to dry at room temperature for 2 hours to observe the degree of damage as defined below. The degree of damage for the water resistance is rated according to EN 12720-2009 as a scale of 0-5, where 0 is the worst, and 5 is the best, as follows:
5—No change: Test area indistinguishable from adjacent surrounding area;
4—Minor change: Test area distinguishable from adjacent surrounding area, only when the light source is directed on the test surface and reflected towards the observer's eye. The minor change could be some slight discoloration and change in gloss, but no change in the surface structure such as swelling, fiber raising, cracking and/or blistering;
3—Moderate change: Test area distinguishable from adjacent surrounding area, visible in several viewing directions, for example, discoloration; change in gloss and color; but no change in the surface structure such as swelling, fiber raising, cracking and/or blistering;
2—Significant change: Test area clearly distinguishable from adjacent surrounding area, visible in all viewing directions, for example, discoloration; change in gloss and color; and/or slightly change in the surface structure such as swelling, fiber raising, cracking and/or blistering.
1—Strong change: The structure of the surface being distinctly changed and/or discoloration, change in gloss and color, and/or the surface material being totally or partially removed, and/or the filter paper adhering to the surface.

The higher the rating level, the better the water resistance.

### Pencil Hardness

Pencil hardness of coating films on the coated glass panels prepared above was determined according to GB/T 23999-2009 for Water based Coating for Woodenware for Indoor Decorating and Refurbishing (Hardness section—GB/T 6739). The hardness of the hardest pencil lead that does not leave a mark on the coating films is recorded as the pencil hardness. A pencil hardness F or harder is acceptable.

### Gloss

Gloss of coating films on coated vinyl chart prepared above was measured according to ASTM D523 using a BYK Micro-Tri-Gloss meter. Acceptable gloss on a 60° Gardner Gloss scale is <50.

### Haze

Haze of coating films on the coated glass panels prepared above was measured using BYK Haze-gard dual haze meter according to ASTM D1003. A haze value <33 indicates acceptable clarity. The lower haze value, the higher clarity.

### Fineness

Fineness of a coating composition was tested using a scraper fineness meter QXD 100 (Shanghai Modern Environment Engineering Technique Co., Ltd., detection limit: 10-100 μm) at room temperature, according to ASTM D1210-96. A coating composition with fineness less than 40 μm is acceptable and considered as a stable coating composition.

### Binding Power

An aqueous acrylic (co)polymer dispersion (also as “latex”) (10.7 g by dry weight), 2.5 g of the above-prepared Zn/ammonia solution (comprising 6.57% Zn²⁺), and water were mixed to form a mixture (100 g). The mixture was left still at room temperature for 1 week. Then 1 g of the mixture was taken out from the container and centrifuged at 80000 revolutions per minute (RPM) for 10 minutes. The obtained supernatant liquid was analyzed by inductively coupled plasma-optical emission spectrometry (ICP-OES) Agilent 5800. The weight of Zn ions in the resulting supernatant liquid per gram of the supernatant liquid was reported as W (μg/g). The binding power of the latex is calculated by the following equation:

$$Binding power of latex = \frac{2.5 \times 6.57 \% - \frac{W}{1 {0}^{4}}}{2.5 \times 6.57 \%}$$

### Coating Compositions

Tables 2-4 list components for preparing IE and CE coating composition samples, respectively, with the amount of each component reported in gram (g), unless otherwise stated.

### IEs 1-11 and CEs 1, 4-9, 11-12, and 14 Coating Composition Samples:

An aqueous solution of a non-alkali metal complex or salt (the zinc/ammonia solution or AlCl₃ solution prepared above) was first added into a latex binder and mixed using a disperser at a speed of 200-500 RPM to form a homogenous blend, and the pH value of the obtained admixture was adjusted to 9.5 by using ammonia solution. The potassium lithium silicate solution (CB-956) was first diluted using water in an amount listed in Tables 2 and 3 and then added to the above admixture. The rest of components such as defoamer, wetting agent, coalescent, and thickeners if present, were further added and mixed at a speed of 200-1,000 RPM for 10 minutes until homogeneous coating compositions were obtained. The resultant coating composition samples were characterized according to the test methods described above and characterization results are given in Tables 2 and 3.

### CEs 2, 3, 10, 13, 15 and 16 Coating Composition Samples:

Based on formulations listed in Table 3, water, defoamers, wetting agent, and coalescent were first added into a latex binder sequentially and mixed using a disperser at a speed of 200-500 RPM to form a homogenous blend. OPTI-MATT AB-2, TS 100, and magnesium (Mg) silicate (zinc dust or zinc phosphate) were added into the blend according to the formulations in Table 3 and mixed at a speed higher than 1200 RPM for 10 minutes. Thickeners were last added and mixed at a speed of 200-500 RPM until homogeneous coating compositions were obtained. The resultant coating composition samples were characterized according to the test methods described above and characterization results are given in Table 3.

As shown in Tables 2 and 3, all IEs 1-11 coating composition samples provided coatings films with good matting effect (gloss at 60°<50), desirable hardness (>HB), and high clarity (haze value <33). As compared to CE 1 free of both zinc/ammonia solution and water-soluble silicate salt solution, IEs 1 and 2 provided coating films with significantly reduced gloss (indicating the matting effect achieved) and enhanced hardness.

All IE coating compositions showed higher matting efficiency (i.e., achieving larger gloss reduction at using lower concentration of soluble silicates and non-alkali metal ion salt relative to the coating composition weight) than CE 3 and also achieved higher hardness than CEs 2 and 3 comprising traditional matting agents.

Coating compositions with dry non-alkali metal ions/dry silicate ratios outside the claimed ranges (CEs 7 and 9) provided coating films with higher gloss (insufficient matting effect).

The coating composition sample of CE 4 with a high non-alkali metal ions/latex binder ratio (by dry weight) was not stable. CE 8 provided coating films with undesirably low hardness due to insufficient amounts of non-alkali metal ions and failed to provide matting effect.

When the amount of latex binder is out of the claimed ranges, the coating compositions either provided a high haze value (CE 5) or undesirably high gloss (CE 6). Without bound by theory, the latex content is important to stabilize the mixture of non-alkali metal ions and water-soluble alkali metal silicate salt before drying coating compositions.

CE 10 substantially repeated Example 2 of U.S. Pat. No. 7,652,087B2 comprising 40.98% of soluble silicate salt and 10.25% of insoluble zinc phosphate (by weight based on the weight of the coating composition) failed to provide a clear coating film as indicated by the high haze value.

Only using zinc/ammonia solution in the absence of water-soluble silicates (CE 11) or incorporating water-soluble alkali metal silicates only in the absence of non-alkali metal ions (CE 12) provided coating films with undesirably high gloss. Also, incorporation of insoluble silicates (e.g., Mg silicate) without non-alkali metal ions produced matt films, but resulted in undesirably high haze values (CE 13). When the dry weight ratio of non-alkali metal ions to alkali metal silicate is too high (CE 14), the coating composition was not stable as indicated by fineness higher than 40. Adding zinc dust (a solid filler) into the latex binder in the absence of water-soluble alkali metal silicate resulted in sediment (CE 15), therefore, unable to make paints. The coating composition of CE 16 comprising, based on the weight of the coating composition, 3% of zinc phosphate (an insoluble zinc filler) showed poor clarity.

TABLE 2
IE coating compositions and characterization

| Component | IE 1 | IE 2 | IE 3 | IE 4 | IE 5 | IE 6 | IE 7 | IE 8 | IE 9 | IE 10 | IE 11 |
|---|---|---|---|---|---|---|---|---|---|---|---|
| ROSHIELD PR-600 | 65 | 65 | 65 | | | 65 | 65 | 44 | 60 | 65 | 65 |
| ROSHIELD P200 | | | | 65 | | | | | | | |
| RHOPLEX WL-91 | | | | | 65 | | | | | | |
| CB-956 | 5 | 10 | 5 | 5 | 5 | 10 | 10 | 10 | 2 | 3 | 10 |
| Water | 25 | 25 | 25 | 25 | 25 | 25 | 25 | 25 | 0 | 25 | 25 |
| Zinc/ammonia solution | 5.0 | 5.0 | | 5 | 5 | 10 | 0.58 | 1 | 1.5 | 4.5 | 12 |
| AlCl₃ solution | | | 3 | | | | | | | | |
| DOWANOL DPnB | | | | 8 | 8 | | | | | | |
| DOWANOL EB | 3 | 3 | 3 | | | 3 | 4 | 4 | 3 | 4 | 3 |
| DOWANOL DB | 3 | 3 | 3 | | | 3 | 4 | 4 | 3 | 4 | 3 |
| BYK-345 | 0.3 | 0.3 | 0.3 | 0.3 | 0.3 | 0.3 | 0.3 | 0.3 | 0.3 | 0.3 | 0.3 |
| BYK-024 | 0.3 | 0.3 | 0.3 | 0.3 | 0.3 | 0.3 | 0.3 | 0.3 | 0.3 | 0.3 | 0.3 |
| Total | 106.6 | 111.6 | 104.6 | 109 | 109 | 117 | 109.18 | 88.6 | 70.1 | 106.1 | 118.6 |
| Characterization | | | | | | | | | | | |
| Dry non-alkali metal ion/ | 27 | 13.5 | 14.6 | 27 | 27 | 27 | 1.57 | 2.7 | 20.25 | 40.5 | 32.4 |
| dry silicate (%) | | | | | | | | | | | |
| Dry non-alkali metal ion/ | 1.20 | 1.20 | 0.65 | 1.27 | 1.27 | 2.40 | 0.14 | 0.36 | 0.39 | 1.09 | 2.90 |
| dry latex (%) | | | | | | | | | | | |
| Wet latex/wet coating (%) | 61.0 | 58.0 | 62.0 | 60.0 | 60.0 | 56.0 | 59.5 | 49.7 | 85.6 | 61.3 | 54.8 |
| Dry latex/wet coating (%) | 26.2 | 25.0 | 26.7 | 24.5 | 24.8 | 24.0 | 25.6 | 21.4 | 36.8 | 26.3 | 23.6 |
| Dry silicate/wet coating (%) | 1.2 | 2.24 | 1.2 | 1.15 | 1.15 | 2.14 | 2.29 | 2.82 | 0.71 | 0.71 | 2.1 |
| Wet silicate/wet coating (%) | 4.69 | 8.96 | 4.78 | 4.60 | 4.60 | 8.58 | 9.16 | 11.29 | 2.85 | 2.83 | 8.43 |
| Fineness (μm) | <10 | <10 | <10 | <10 | <10 | <10 | <10 | 25 | <10 | 20 | 30 |
| Gloss at 60° | 45.7 | 11.2 | 24.1 | 46.1 | 31 | 9.2 | 31 | 24 | 37 | 45 | 8.7 |
| Hardness | H | H | H | H | H | H | H | H | F | F | H |
| Haze | 9.5 | 30.2 | 21.6 | 13.6 | 18.6 | 28.1 | 22.1 | 20.2 | 11.6 | 9.9 | 29.3 |

### IEs 12-16 Coating Composition Samples

Coating composition samples of IEs 12-16 were prepared according to the same procedure as for JE 1 based on formulations given in Table 4, except EDTA was further added after incorporating the zinc/ammonia complex salt solution. The resultant coating composition samples were characterized according to the test methods described above and characterization results are given in Table 4. As shown in Table 4, the latex binders having binding power of lower than 0.975 in combination with EDTA all provided stable coating compositions, as indicated by low fineness (<40 μm). At the same time, these coating compositions all provided coating films with balanced properties including gloss at 60°<50, hardness of F or harder, and good clarity (haze values <33), as well as surprisingly good water resistance (ratings >3).

TABLE 4
IE coating compositions and characterization

| Component | IE 12 | IE 13 | IE 14 | IE 15 | IE 16 |
|---|---|---|---|---|---|
| ROSHIELD 500 | 65 | 65 | | | 65 |
| MAINCOTE HG-54C | | | 65 | 65 | |
| CB-956 | 20 | 10 | 10 | 10 | 20 |
| Water | 10 | 25 | 25 | 25 | 10 |
| Zinc/ammonia solution (30%) | 5 | 10 | 10 | 10 | 5 |
| EDTA | 0.5 | 0.25 | 0.25 | 0.1 | 0.55 |
| DOWANOL DPnB | | 6 | 6 | 6 | |
| DOWANOL EB | 4 | | | | 4 |
| DOWANOL DB | 4 | | | | 4 |
| BYK-345 | 0.3 | 0.3 | 0.3 | 0.3 | 0.3 |
| BYK-024 | 0.3 | 0.3 | 0.3 | 0.3 | 0.3 |
| Characterization | | | | | |
| EDTA content | 0.0046 | 0.0021 | 0.0021 | 0.000857 | 0.005039 |
| Latex binder content | 0.596 | 0.556 | 0.556 | 0.557 | 0.596 |
| Dry non-alkali metal ions/dry silicate | 0.0657 | 0.2628 | 0.2628 | 0.2628 | 0.0657 |
| Dry non-alkali metal ions /dry latex | 0.0126 | 0.0253 | 0.0244 | 0.0244 | 0.0126 |
| Gloss at 60° | 8.2 | 21.3 | 31 | 35 | 35 |
| Fineness (μm) | 30 | 30 | 35 | 40 | 30 |
| Haze | 23.4 | 25.2 | 22 | 22.7 | 13.4 |
| Water resistance | 4 | 4 | 4 | 4 | 4 |
| Hardness | F | F | H | F | H |

*ROSHIELD 500 and MAINCOTE HG-54C latex binders had binding power of 0.577 and 0.972, respectively, as measured according to the Binding Power test method above.
EDTA content refers to the ratio of the weight of EDTA to the weight of the coating composition.

TABLE 3
CE coating composition and characterization

| | CE | CE | CE | CE | CE | CE | CE | CE | CE | CE | CE | CE | CE | CE | CE | CE |
|---|---|---|---|---|---|---|---|---|---|---|---|---|---|---|---|---|
| Component | 1 | 2 | 3 | 4 | 5 | 6 | 7 | 8 | 9 | 10 | 11 | 12 | 13 | 14 | 15 | 16 |
| ROSHIELD | 65 | 65 | 65 | 65 | 36.78 | 90 | 65 | 65 | 55 | 20 | 40 | 40 | 40 | 25 | 10 | 65 |
| PR-600 | | | | | | | | | | | | | | | | |
| CB-956 | | | | 10 | 10 | 1.7 | 4.1 | 8 | 10 | 40 | | 10 | | 40 | | |
| Water | 30 | 25 | 25 | 25 | 25 | | 25 | 25 | 25 | 25 | 25 | 20 | 20 | 3.4 | 1.4 | 25 |
| Zinc/ammonia | | | | 15 | 0.58 | 1.42 | 7 | 0.5 | 0.5 | | 20 | | | 25 | 12 | |
| solution | | | | | | | | | | | | | | | | |
| OPTI-MATT | | 25 | | | | | | | | | | | | | | |
| AB-2 | | | | | | | | | | | | | | | | |
| TS 100 | | | 4 | | | | | | | | | | | | | |
| Mg silicate | | | | | | | | | | | | | 10 | | | |
| Zn dust | | | | | | | | | | | | | | | 70 | |
| Zinc phosphate | | | | | | | | | | 10 | | | | | | 3 |
| DOWANOL EB | 3 | 3 | 3 | 3 | 4 | 3 | 4 | 3 | 4 | 1 | 1 | 2 | 2 | 3 | 3 | 3 |
| DOWANOL DB | 3 | 3 | 3 | 3 | 4 | 3 | 4 | 3 | 4 | 1 | 1 | 2 | 2 | 3 | 3 | 3 |
| BYK-345 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 |
| BYK-024 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 |
| Total | 101.6 | 122 | 101 | 121.6 | 80.96 | 99.72 | 109.7 | 105.1 | 99.1 | 97.6 | 87.6 | 74.6 | 74.6 | 100 | 100 | 99.6 |
| Characterization | | | | | | | | | | | | | | | | |
| Dry non-alkali | NA | NA | NA | 40.5 | 1.57 | 21.88 | 44.82 | 1.64 | 1.31 | NA | NA | NA | NA | 62.5 | NA | NA |
| metal ions/ | | | | | | | | | | | | | | | | |
| dry silicate (%) | | | | | | | | | | | | | | | | |
| Dry non-alkali | | | | 3.62 | 0.25 | 3.52 | 1.64 | 0.12 | 0.14 | | | 0.00 | | | 18.46 | |
| metal ions/ | | | | | | | | | | | | | | | | |
| dry latex (%) | | | | | | | | | | | | | | | | |
| Wet latex/ | 64.0 | 53.0 | 65.0 | 53.5 | 45.4 | 90.3 | 59.3 | 61.9 | 55.5 | 20.5 | 45.7 | 53.6 | 53.6 | 25.0 | 10.0 | 65.3 |
| (wet coating %) | | | | | | | | | | | | | | | | |
| Dry latex/ | 27.5 | 23.0 | 27.8 | 23.0 | 19.5 | 38.8 | 25.5 | 26.6 | 23.9 | 8.8 | 19.6 | 23.1 | 23.1 | 10.8 | 4.3 | 28.1 |
| wet coating (%) | | | | | | | | | | | | | | | | |
| Dry silicate/ | | | | 2.06 | 3.09 | 0.43 | 0.93 | 1.9 | 2,52 | | 0 | 3.351 | 0 | 200 | 0 | 0 |
| wet coating (%) | | | | | | | | | | | | | | | | |
| Wet silicate/ | | | | 8.22 | 12,35 | 1.70 | 3.74 | 7.61 | 10.09 | 40.98 | 0.00 | 13.40 | 0.00 | 40.00 | 0.00 | 0.00 |
| wet coating (%) | | | | | | | | | | | | | | | | |
| Insoluble filler/ | | | | | | | | | | 10.25 | 0.00 | | 13.40 | | 70.00 | 3.01 |
| wet coating (%) | | | | | | | | | | | | | | | | |
| Fineness (μm) | <5 | 15 | 30 | 25 | <5 | <5 | 10 | <5 | <5 | 80 | <5 | <5 | 60 | >100 | >100 | 60 |
| Gloss at 60° | 95 | 21.9 | 54.8 | 16.2 | 2.4 | 66.2 | 53 | 61.8 | 55.3 | 35 | 90 | 95 | 25 | | | 67.2 |
| Hardness | F | HB | HB | F | | | | HB | | | | | | | | |
| Haze | 3.7 | 42.7 | 30.8 | 60.1 | 53.2 | | | 8.6 | | 59.8 | | | 60.3 | | | 35.2 |

In table 2, table 3, and table 4 above:
Dry non-alkali metal ions/dry silicate = [(non-alkali metal salt solution weight × non-alkali metal ion solids content)/(silicate salt solution × silicate solids content)] × 100%;
Dry non-alkali metal ions/dry latex = [(non-alkali metal salt solution weight × non-alkali metal ion solids content)/(latex binder weight × latex binder solids content)] × 100%;
Wet latex/wet coating = (latex binder weight)/(coating composition weight) × 100%;
Dry latex/wet coating = (latex weight × latex solids content)/(coating composition weight) × 100%;
Dry silicate/wet coating = (alkali metal silicate salt solution weight × silicate salt solution solids content)/(coating composition weight) × 100%;
Wet silicate/wet coating = (weight of alkali metal silicate salt solution)/(coating composition weight) × 100%;
Insoluble filler/wet coating = (insoluble filler weight)/(coating composition weight) × 100%;
ROSHIELD PR-600 and P200 latex binders had binding power of 0.998 and 0.991, respectively, as measured according to the Binding Power test method above.

1. A coating composition comprising, based on the weight of the coating composition,
(a) from 20% to 38.5% by dry weight of an aqueous dispersion of an acrylic (co)polymer;
(b) from 0.5% to 2.9% by dry weight of a water-soluble alkali metal silicate;
(c) an aqueous solution of a water-soluble non-alkali metal salt, comprising non-alkali metal ions; and
(d) from zero to 2% by dry weight of a microfiller;
wherein the aqueous solution of the non-alkali metal salt is present in an amount to provide a dry weight ratio of the non-alkali metal ions to the acrylic (co)polymer is a range of 0.13% to 3.3% and a dry weight ratio of the non-alkali metal ions to the water-soluble alkali metal silicate in a range of 1.4% to 42%.

2. The coating composition of claim 1, wherein the non-alkali metal ions comprise zinc ions, aluminum ions, zirconium ions, or mixtures thereof.

3. The coating composition of claim 1, wherein the alkali metal silicate is a lithium potassium silicate.

4. The coating composition of claim 1, wherein the acrylic (co)polymer is a multistage acrylic (co)polymer having a Tg in a range of from 0 to 80° C. and comprising a polymer A and a polymer B at a weight ratio of the polymer A to polymer B in a range of from 78:22 to 22:78,
wherein a Tg difference between the polymer A and the polymer B is 40° C. or more, and
wherein the multistage acrylic (co)polymer comprises, by weight based on the weight of the multistage acrylic (co)polymer,
from 10% to 40% of structural units of a cycloalkyl (meth)acrylate;
from 40% to 85% of structural units of a C₄-C₂₀-alkyl (meth)acrylate, a vinyl aromatic monomer, or mixtures thereof; and
from 0.5% to 10% of structural units of an acid monomer, the salt thereof, or mixtures thereof.

5. The coating composition of claim 1, wherein the acrylic (co)polymer is a multistage acrylic (co)polymer comprising a polymer A and a polymer B,
wherein the polymer A has a number average molecular weight of from 3,000 to 50,000 and comprises, by weight based on the weight of the polymer A,
(a1) from 2.1% to 10% of structural units of a carbonyl-containing functional monomer;
(a2) from 5% to 15% of structural units of an acid monomer, the salt thereof, or mixtures thereof; and
(a3) from 75% to 92% of structural units of methyl (meth)acrylate, ethyl (meth)acrylate, or mixtures thereof; and
wherein the polymer B comprises, by weight based on the weight of the polymer B,
(b1) from 0.8% to 10% of structural units of a carbonyl-containing functional monomer and
(b2) from 90% to 99.2% of structural units of an additional ethylenically unsaturated nonionic monomer;
wherein the polymer B has a glass transition temperature at least 40° C. lower than that of the polymer A, and the weight ratio of the polymer A to the polymer B is from 38:62 to 55:45.

6. The coating composition of claim 1, wherein the acrylic (co)polymer comprises, by weight based on the weight of the acrylic (co)polymer, from 1% to 33% of structual units of a hydroxy-functional alkyl (meth)acrylate.

7. The coating composition of claim 1, further comprising from 0.06% to 0.52% by weight of ethylenediaminetetraacetic acid, a salt thereof, or mixtures thereof, based on the weight of the coating composition.

8. The coating composition of claim 1, wherein the coating composition comprises less than 30% by dry weight of the aqueous dispersion of the acrylic (co)polymer, based on the weight of the coating composition.

9. The coating composition of claim 1, comprising 0.9% by dry weight or higher of the water-soluble alkali metal silicate, based on the weight of the coating composition.

10. A method of preparing the coating composition of claim 1, comprising:
(i) admixing the aqueous dispersion of the acrylic (co)polymer with the aqueous solution of the water-soluble non-alkali metal salt, thereby forming an admixture;
(ii) further admixing the admixture obtained from step (i) with the water-soluble alkali metal silicate and the microfiller if present; and optionally,
adding from 0.06% to 0.52% by weight of ethylenediaminetetraacetic acid, a salt thereof, or mixtures thereof, based on the total weight of the coating composition, into the admixture obtained from step (i) and prior to step (ii).
